(19) United States
(12) Patent Application Publication
(10) Pub. No.: US 2009/0307057 A1
(43) Pub. Date: Dec. 10, 2009

(54) ASSOCIATIVE MEMORY OPERATORS, METHODS AND COMPUTER PROGRAM PRODUCTS FOR USING A SOCIAL NETWORK FOR PREDICTIVE MARKETING ANALYSIS

(76) Inventors: Albert Azout, New York, NY (US); Manuel Aparicio, IV, Cary, NC (US)

Correspondence Address: MYERS BIGEL SIBLEY & SAJOVEC, PO BOX 37428, RALEIGH, NC, 27627, US

(21) Appl. No.: 12/478,380

(22) Filed: Jun. 4, 2009

Related U.S. Application Data
(60) Provisional application No. 61/059,466, filed on Jun. 6, 2008.

(51) Int. Cl. G06Q 10/00; G06G 7/62; G06Q 90/00

(52) U.S. Cl. 705/10; 703/13; 705/1

(57) ABSTRACT

Provided are an associative memory operator system and methods for predictive marketing analysis using a computer implemented social network. A system includes multiple associative memory cells corresponding to multiple computer implemented social network users. A respective one of the associative memory cells corresponds to a user in the computer implemented social network and includes a sink memory of associations corresponding to which ones of the computer implemented social network users have been influenced by the user and a source memory of associations corresponding to which other ones of the computer implemented social network users have influenced the user.

### RELATED APPLICATIONS

This non-provisional patent application claims priority to U.S. Provisional Application Ser. No. 61/059,466, filed Jun. 6, 2008, the disclosure of which is hereby incorporated herein by reference as if set forth fully herein.

### BACKGROUND

This invention relates to artificial intelligence systems and methods, and more particularly to associative memory operators and methods and computer program products for operating same.

Commercial entities may have a need to market their products and services to potential customers. Historically, some businesses have relied on non-targeted advertising systems such as, for example, mass mailings and the like. This approach, however, lacks the ability to target specific potential customers for specific products and/or services.

In an effort to more focus marketing efforts, some commercial entities have purchased previously compiled statistical data. However, data obtained by this method may be limited to small samples of the population and may be limited to historical data. In this regard, the data may be generalized and thus unable to provide commercial entities any information regarding the desires or needs of specific potential customers.

Some commercial entities conduct surveys via telemarketing and/or other types of research companies. Telemarketing approaches, however, may require commercial entities to contact all potential customers absent any knowledge as to the likelihood that any particular one will purchase a specific product or service. Still other marketing approaches may include prompting consumers to complete a survey that may be compiled to create a demographic characterization of the potential customer relative to other customers. Such approaches may rely on linearly mapped characterizations of potential customers that provide customized reports to commercial entities. Such approaches, however, may be limited in reaching beyond potential customers who are willing to complete surveys. Additionally, simple look-up tables corresponding to survey results based on existing products may be ineffective in providing substantial predictive value, especially in the context of new products.

### SUMMARY

Some embodiments of the present invention include methods of accumulating influence information regarding a user in at least one computer implemented social network. Methods may include observing, into a sink portion of a source agent associative memory, source interest event data that corresponds to an interest event in which a user agent is influenced by the source agent and observing, into a source portion of a user agent associative memory that corresponds to the user agent, user interest event data that corresponds to the interest event.

In some embodiments, the interest event includes a look event that corresponds to the user accessing event related information without performing a transaction or a buy event that corresponds to the user conducting a transaction.

Some embodiments include, before observing into a sink portion and before observing into a source portion, determining an object vector corresponding to the interest event that includes a unique object identifier, an object class or object attributes, determining a source vector corresponding to the interest event that includes interest event source data, and determining an environment vector corresponding to the interest event that includes interest event environmental data. In some embodiments, the interest event environment data includes weather data, season data, temporal data, and/or economic trend data.

Some embodiments include generating a combined vector from an object vector, a source vector and an environment vector. In some embodiments, the source interest event data includes the combined vector and user identification data. Some embodiments include generating a combined vector from an object vector, a source vector and an environment vector. In some embodiments, observing, into a source portion of a user agent associative memory that corresponds to the user agent, user interest event data that corresponds to the interest event includes retrieving user identity data and replacing the source identity data in the combined vector with the user identity data to generate a modified combined vector and for each source identity, retrieving source user agent identity data and including the source user agent identity data in the modified combined vector and storing the modified combined vector in the source portion.

Some embodiments of the present invention include methods of simulating adoption propagation of a proposed object in an associative entity network corresponding to at least one computer implemented social network. Some embodiments of such methods include generating multiple entry points in the associative entity network, the entry points configured to simulate respective source agents for introducing the proposed object into the computer implemented social network and determining a likelihood of adoption of the proposed object for each of multiple sink agents that are identified in the source agent's source memory.

In some embodiments, generating the entry points includes determining desiring users based on previous user activity that corresponds to a similar object to the proposed object and/or objects including at least one object attribute that is substantially similar to a proposed object attribute. Some embodiments provide that generating the entry points includes determining influential users based on respective measures of computer implemented social network centrality.

In some embodiments, determining a likelihood of adoption of the proposed object for each of the sink agents that are in identified in the source agent's source memory includes computing a social pressure as a binary value that represents whether or not the respective sink agents are likely to adopt the proposed object. Some embodiments provide that computing social pressure includes generating an ego radial-N directed, weighted subgraph representing a conceptual network for ones of the plurality of sink agents using respective ones of the sink agents' sink memories, the subgraph including one or more influencing agents and corresponding directional weighted influence values. Some embodiments may further include estimating a constraint-free aversion for ones of the sink agents, the constraint-free aversion corresponding to non-desirability of the proposed object and estimating a net change in centrality of respective ones of the sink agents to provide indication corresponding to a change in centrality resulting from an adoption decision. Embodiments may further include determining a measure of adoption using the constraint-free aversion and the net change in centrality to determine if the sink agent will adopt the proposed object.

In some embodiments, determining a likelihood of adoption of the proposed object for each of multiple sink agents that are in identified in the source agent's source memory includes determining a desirability weight for respective ones of the plurality of sink agents corresponding to the proposed object from the source agent.

Some embodiments provide that, before determining a likelihood of adoption of the proposed object for each of multiple sink agents that are in identified in the source agent's source memory, suggesting the proposed object to each of the sink agents that are in identified in the source agent's source memory and storing as a simulation in the associative entity network, a decision regarding whether or not each of the sink agents adopt the proposed object and a time corresponding to the decision.

Some embodiments of the present invention provide a computer program product comprising a computer usable storage medium having computer-readable program code embodied in the medium, the computer-readable program code configured to perform the methods described herein.

Some embodiments of the present invention include associative memory operator systems for predictive marketing analysis using a computer implemented social network. Some embodiments of systems described herein include an associative entity network including multiple associative memory cells, respective one of which correspond to respective ones of multiple computer implemented social network users. Some embodiments provide that respective ones of the associative memory cells include a sink memory of associations corresponding to which other ones of the computer implemented social network users have been influenced by the user and a source memory of associations corresponding to which ones of the computer implemented social network users have influenced the user.

Some embodiments provide that the source memory includes object identification and/or object attribute identification corresponding to an object in which the user influenced a sink user of the computer implemented social network users and the respective sink user identification. Some embodiments provide that the sink memory includes object identification and/or object attribute identification corresponding to an object in which the user was influenced by a source user of the computer implemented social network users and the respective source user identification. In some embodiments, the source memory includes source environmental data corresponding to the object in which the user influenced the sink user, the sink memory includes sink environmental data corresponding to the object in which the user was influenced by the source user, and the sink environmental data and the source environmental data each include at least one of date, day of the week, time of day, season, weather, climate, political climate, and/or economic climate.

Some embodiments include at least one network interface that is configured to present leads, objects and/or news listings regarding objects for consideration by the computer implemented social network users, at least one subject-specific web application server that may be accessed via the at least one network interface and a computer implemented social network service that may provide an interface between the at least one subject-specific web application server and an associative entity network that includes the associative memory cells. In some embodiments, the object includes at least one of information, a product, a service and an event.

Some embodiments provide that the associative memory cells corresponding to computer implemented social network users are operable to perform a simulator function to simulate social pressures between respective ones of the plurality of computer implemented social network users. In some embodiments, the simulator function is operable to generate reports of objects and/or attributes and a corresponding direction of influence between respective ones of the plurality of computer implemented social network users. Some embodiments include a simulator that is configured to provide predictions corresponding to proposed objects in the computer implemented social network using ones of the associative memory cells in the associative entity network

Some embodiments of the present invention include a graphical user interface for an associative entity memory corresponding to at least one computer implemented social network, the interface including a recommendation portion that is operable to provide recommendations to a user in the at least one computer implemented social network from other ones of a plurality of users in the at least one computer implemented social network using the associative entity network.

Some embodiments of the present invention include systems for providing predictive marketing analysis. Systems may include a computer implemented social network that is operable to determine personal and social influence information corresponding to multiple computer implemented social network users and a scalable associative memory based entity network platform that is operable to combine with the computer implemented social network to model how information delivery and discovery take place among the computer implemented social network users, the associative memory including multiple individual user memories corresponding to the computer implemented social network users.

In some embodiments, the scalable associative memory network is further operable to accumulate influence information corresponding to ones of the computer implemented social network users and to simulate cascades of objects proposed in the computer implemented social network to provide predictive information regarding delivery of the objects to consumers. Some embodiments provide that cascades of objects proposed in the computer implemented social network are determined algorithmically.

### BRIEF DESCRIPTION OF THE DRAWINGS

FIG. 1 is a plot illustrating a diffusion of innovation curve explaining the rate of adoption of an innovation over time according to some embodiments of the present invention.

FIG. 2 is a block diagram illustrating a system architecture according to some embodiments of the present invention.

FIG. 3 is a flow diagram illustrating a conceptual network graph according to some embodiments of the present invention.

FIG. 4 is a flow diagram illustrating a conceptual network graph generated for an agent 150 in a music object context 148 according to some embodiments of the present invention.

FIG. 5 is a diagram illustrating individual sink and source memories 160, 162 of an agent 150 in an associative entity network according to some embodiments of the present invention.

FIG. 6 is a network diagram illustrating a cross reference link between a source agent 170 and a sink agent 172 in a specific context according to some embodiments of the present invention.

FIG. 7 is a flow diagram illustrating an observe process for updating and/or populating sink and source memories in accordance with some embodiments of the present invention.

FIG. 8 is a flow diagram illustrating an imagine process for simulating and/or estimating propagation of an object and/or product based on the sink and source memories of the network agents in accordance with some embodiments of the present invention.

FIG. 9 is a table illustrating an exemplary sink memory as applied to an imagine example according to some embodiments of the present invention.

FIGS. 10A and 10B are tables illustrating directory agent look-up functions for finding desiring users according to some embodiments of the present invention.

FIG. 11 is a flow diagram illustrating computing the social pressure corresponding to a conceptual network generated in an imagine process according to some embodiments of the present invention.

FIG. 12 is a block diagram illustrating exemplary outputs from a distributed associative memory operator system according to some embodiments or the present invention.

FIG. 13 is an image depicting a screenshot of a user interface in accordance with some embodiments of the present invention.

FIGS. 14A and 14B are an example of a directed weighted graph illustrating an exemplary conceptual network graph in a specific context and the conceptual network diagram of FIG. 14A including an adoption portfolio, respectively, according to some embodiments of the present invention.

FIG. 15 is block diagram illustrating an exemplary network architecture for a system for providing predictive marketing analysis using at least one associative memory network and a computer-based social network, in accordance with some embodiments.

### DETAILED DESCRIPTION

The present invention now will be described more fully hereinafter with reference to the accompanying drawings, in which illustrative embodiments of the invention are shown. However, this invention may be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “coupled”, “connected” or “responsive” to another element, it can be directly coupled, connected or responsive to the other element, or intervening elements may also be present. In contrast, when an element is referred to as being “directly coupled”, “directly connected” or “directly responsive” to another element, there are no intervening elements present. Like numbers refer to like elements throughout. As used herein the term “and/or” includes any and all combinations of one or more of the associated listed items and may be abbreviated by “/”.

It will also be understood that, although the terms first, second, etc. may be used herein to describe various elements, these elements should not be limited by these terms. These terms are only used to distinguish one element from another element.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention is described in part below with reference to block diagrams and/or flowcharts of methods, systems and computer program products according to embodiments of the invention. It will be understood that a block of the block diagrams or flowcharts, and combinations of blocks in the block diagrams or flowcharts, may be implemented at least in part by computer program instructions. These computer program instructions may be provided to one or more enterprise, application, personal, pervasive and/or embedded computer systems, such that the instructions, which execute via the computer system(s) create means, modules, devices or methods for implementing the functions/acts specified in the block diagram block or blocks. Combinations of general purpose computer systems and/or special purpose hardware also may be used in other embodiments.

These computer program instructions may also be stored in memory of the computer system(s) that can direct the computer system(s) to function in a particular manner, such that the instructions stored in the memory produce an article of manufacture including computer-readable program code which implements the functions/acts specified in block or blocks. The computer program instructions may also be loaded into the computer system(s) to cause a series of operational steps to be performed by the computer system(s) to produce a computer implemented process such that the instructions which execute on the processor provide steps for implementing the functions/acts specified in the block or blocks. Accordingly, a given block or blocks of the block diagrams and/or flowcharts provides support for methods, computer program products and/or systems (structural and/or means-plus-function).

It should also be noted that in some alternate implementations, the functions/acts noted in the flowcharts may occur out of the order noted in the flowcharts. For example, two blocks shown in succession may in fact be executed substantially concurrently or the blocks may sometimes be executed in the reverse order, depending upon the functionality/acts involved. Finally, the functionality of one or more blocks may be separated and/or combined with that of other blocks. It will also be understood that, in many systems that are already equipped with some form of microprocessor-based computational capability, the blocks of the block diagram may be embedded within operating and/or application programs that execute on the microprocessor.

In recent years, commercial entities have turned increasingly to technology-related marketing analysis and advertising techniques. As such, potential customers have been increasingly overloaded with a wealth of information via, for example, the Internet. In this regard, competition for the attention of potential customers may be increasingly important. For example, people may be passive by nature when it comes to information retrieval. In this regard, social networks may constitute an important source of what people know by helping filter the overabundance of information. A social network may be a social structure made of nodes (which may be individuals or organizations) that are tied by one or more specific types of interdependency, such as values, visions, ideas, web links, financial exchange, friends and/or trade, among others. The resulting structures may be very complex. Some embodiments provide that a social network includes an electronic social network that includes users who may rely on computer, telecommunication and/or electronic networks to support social interactions among socially connected users.

One example of a social filter that may be used to filter large quantity of information may include a collaborative filter that provides recommendations regarding potential products. The recommendations may be provided by correlating users exhibiting similar tastes. Collaborative filtering may be utilized to provide a recommender system that may benefit from the effects of social influence.

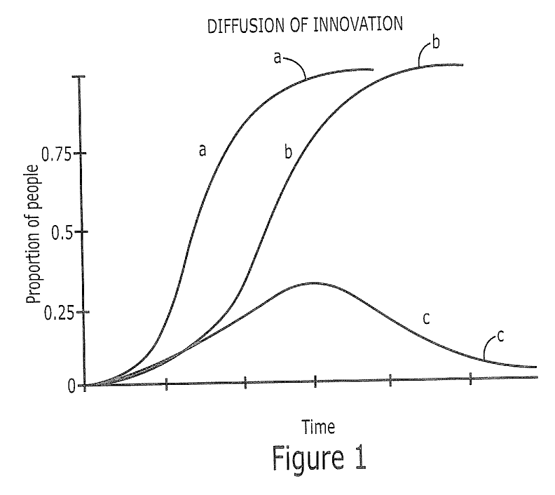

The extent of social influence on decision-making may be described in terms of the diffusion of innovations through social networks. For example, referring to FIG. 1, the diffusion of innovation may be described as a S-curve in explaining the rate of adoption of an innovation over time. For example, as illustrated, curve “a” represents the proportion of people who know of a given innovation, curve “b” represents a cumulative proportion of people who have adopted an innovation, and curve “c” represents the proportion of people who adopt the innovation at time t. Innovation diffusion may be driven by “cascades” in social networks. Cascade may occur through communications and adoption of innovations through social networks. In some cases, depending on how a graph is connected, the spread of an idea locally may soon reach global proportions. The formation and structure of influence in a social network may affect the cascade propensity of an innovation (i.e., the probability that an innovation will diffuse).

Much like with innovation diffusion, at some point in social network formation, certain individuals connect to large clusters together, making the network exponentially more interconnected. For example, in the case of adoption, these individuals may make the innovation “explode” in a viral way. These network individuals, referred to as “connectors,” may be essential to the overall adoption of an innovation. Thus, as a function of social network formation, certain individuals may experience structural positions of power through their connectivity. In this manner, these individuals may have enormous influence over the opinions of other individuals and, thus, on the adoption of products and services.

The spread of influence may be maximized in a social network by identifying the “connectors”. Influence of the social network may be a function of visibility such that individuals who are in distinct structural positions may experience a large amount of exposure. In this regard, choosing the individuals who are the most visible in relation to others and, thus, the probability that an individual is influenced by the chosen one, may be important. In this manner, the probability that one user will be influenced by another may be determined as a function of the weighted potential of influence from one node to another within a given context.

The probability that one user will be influenced by another may be estimated using, for example, three interrelated social network metrics: centrality, cohesion, and structural equivalence. Centrality is a measure of how central or prestigious a user is to the network. Cohesion is a measure of how often the users share similar connections and structural equivalence is a measure of the extent that the users share similar positions in the network, even if they themselves are not related. In some embodiments, this measure may be utilized to capture how much the users are in competition, for example.

Once we have an idea of the weights of user influences in a given network, based on interpersonal visibility metrics of users in the system, determining the probability that, given the network of influence, a user will adopt a product and that the collective adoption of the products will yield a network cascade may be determined using the concept of context. For example, individuals act and live within certain contexts. Communities often form around contexts such that users share similar likes and dislikes (i.e., homophily). In this regard, physical and social networks may be arranged around different contexts and the influences themselves may depend on the context in which the information is being retrieved. Stated differently, by considering context, social networks may be adequately positioned to deliver relevant things to individuals through the network connections. For example, an influence network for a user regarding the selection of electronic devices may be substantially distinct from an influence network for the same user regarding the selection of, for example, books, music and/or entertainment content. Accordingly, embodiments herein may utilize context and depth of knowledge in determining a network of influence.

In some embodiments, context and depth of knowledge in a social network may be determined using associative memory networks as described in U.S. Published Patent Application No. 2007/0299797 A1, and/or U.S. Pat. Nos. 7,016,886, 6,052,679, 6,581,049, 7,478,090, 7,478,192, and/or 7,333,917, which are incorporated by reference as if fully set forth herein. An associative memory may perform the retrieval of information that is associated with, or related to, the information at hand. Associative lookup may be inherently flexible because of the ability to perform lookup based on similarity and/or proximity as opposed to the more brittle and explicit features of an index-based lookup. For example, associative entity networks may provide networks of entities that display entity interrelationships based on a specific context. This may be important because entities may be related to each other in different ways depending on different contexts. Every entity in the system may be embedded with an associative memory that maintains the specific details of the entity and how it interrelates to other entities.

Some embodiments described herein may include a scalable associative memory based entity network platform combined with a social layer and model how information delivery and discovery take place in the real world. The associative memory based entity network platform may provide true knowledge discovery and personalization. The social layer may combine personalization with socialization. In this manner, a discovery platform may be provided that continually sorts for information and delivers relevant items to distributed, but interconnected users. Thus, in addition to focusing on social and/or individual models, social and individual influence forces are incorporated in relation to context. In some embodiments, cascades may be simulated to allow for the delivery of objects (information, products, services, etc.) to consumers. In this manner, recommendations and discovery of real world networks as well as additional functionality may be determined algorithmically.

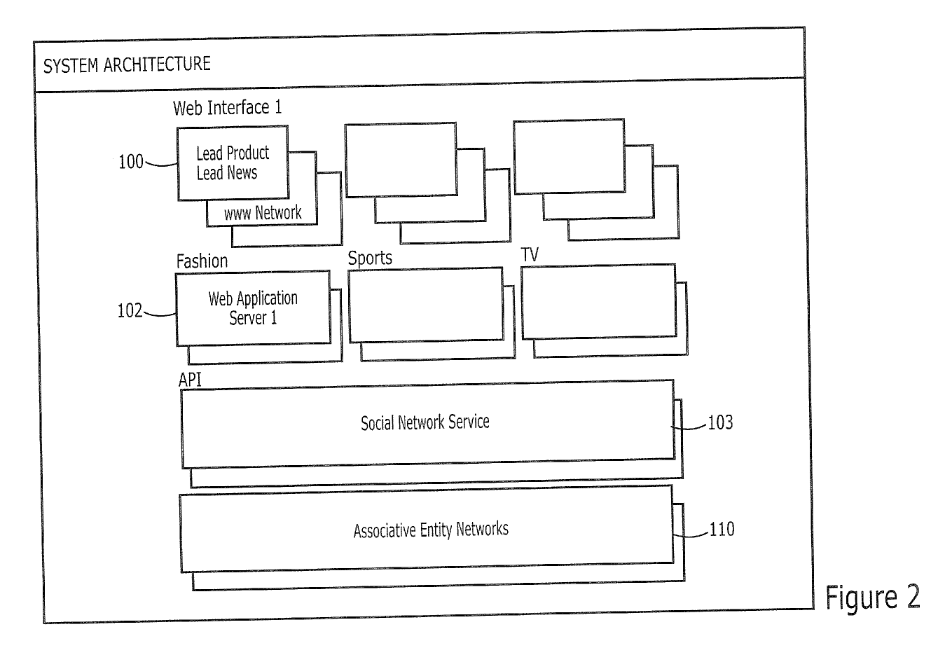

Reference is now made to FIG. 2, which is a block diagram illustrating a system architecture according to some embodiments of the present invention. The system may include one or more network interfaces 100 may be configured to present leads, objects and/or news items regarding objects. In some embodiments, objects may be products, services and/or events, among others. In some embodiments, a network interface 100 may include, for example, an interface corresponding to a wide-area network (WAN), a local area network (LAN), a communications network, and/or an Internet network such as, for example, the World Wide Web (Web), among others. The network interface 100 may also permit a user to view a context dependent network that may provide influence related information. For example, a user may want to determine who or what is influencing them and/or who they are influencing.

In the context of the Web, a network interface 100 may be a web interface that may be provided via, for example, a web application server 102. In some embodiments, a web application server 102 may be subject specific such as, for example, fashion, entertainment, and/or food, among others. In addition to broadcast and/or cable TV, movies, and music, entertainment may also include consumer devices including hygiene-related, communication, data processing and/or transportation related devices such as, for example, automotive. In this regard, a web application server 102 for fashion, for example, may include and/or be interconnected to multiple domains and/or websites. In general, web application servers 102 may be directed to the products, services and/or activities a user may experience and/or decide to experience as part of a normal routine and/or daily experience. In some embodiments, a system may include multiple web application servers 102 that may be directed to a variety of different objects.

The web application servers 102 may be coordinated and/or communicatively coupled to one another and/or to an associative entity network (AEN) 110 via a social network service 103. The social network service 103 may include, for example, an application programming interface (API) that may be configured to interface between the web application servers 102 and the AEN 110. In some embodiments, the AEN 110 may interface with other applications as discussed in U.S. Published Patent Application No. 2007/0299797 A1.

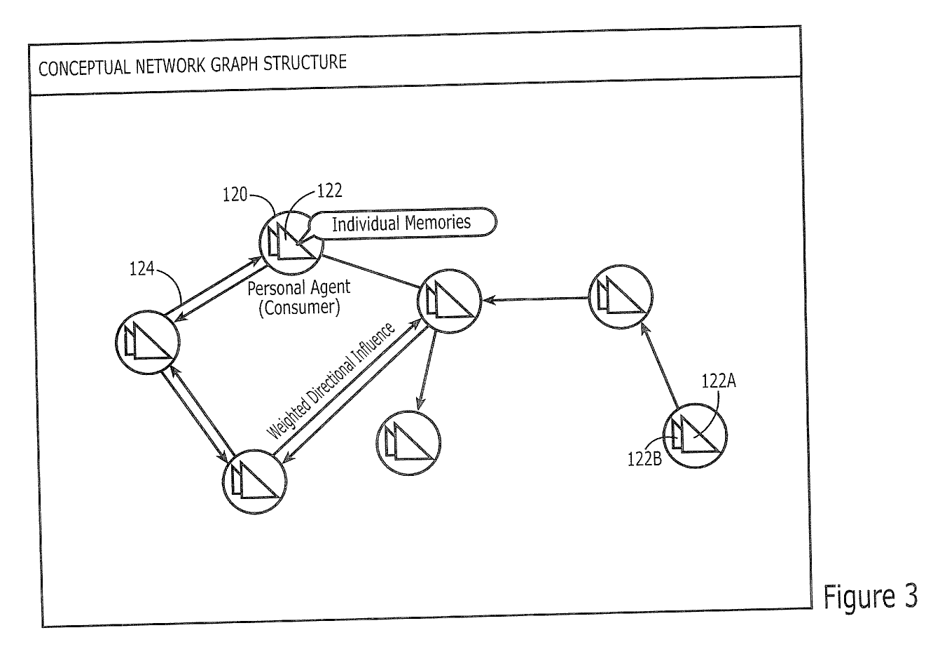

Reference is now made to FIG. 3, which is a flow diagram illustrating a conceptual network graph according to some embodiments of the present invention. In some embodiments, the conceptual network graph may include a radius N directed weighted graph. The AEN may be used to generate a conceptual graph structure that is specific to an agent 120 and a context. For example, an agent 120 in the AEN corresponding to a specific user may include individual memories 122 in the AEN that may be used to determine a weighted directional influence relative to another agent. The individual memories 122 may include a sink memory 122A and a source memory 122B. The source memory 122B may include information regarding who has influenced the user and the sink memory 122A may include information regarding who the user has influenced. The sink and source memories 122A, B may include object features and/or attributes corresponding to the objects subject to the influence.

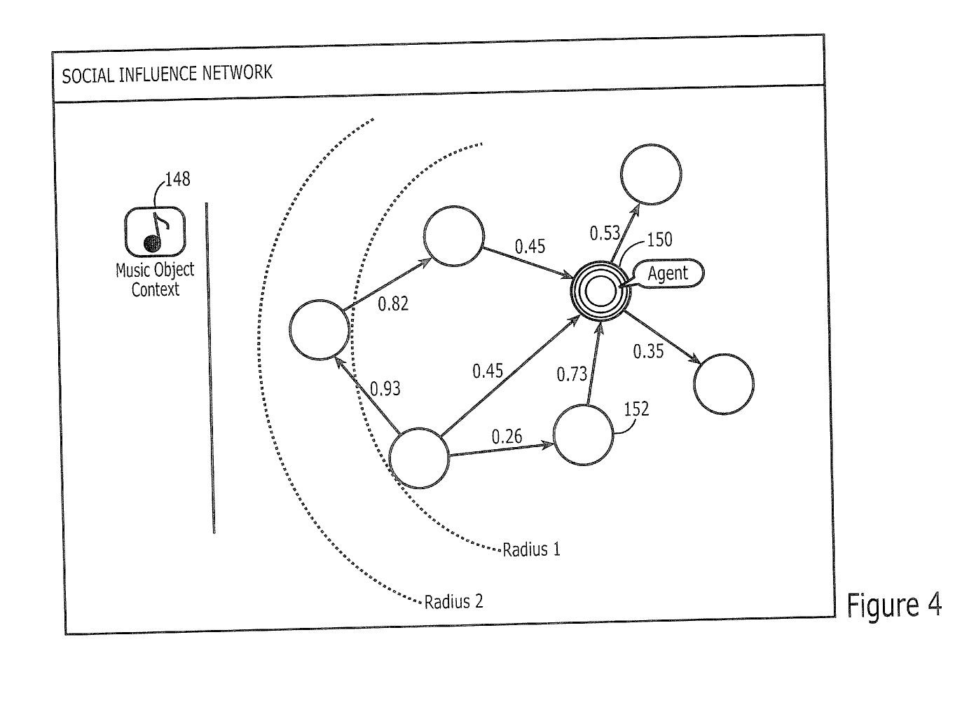

Reference is now made to FIG. 4, which is a flow diagram illustrating a conceptual network graph generated for an agent 150 in a music object context 148 according to some embodiments of the present invention. In some embodiments, the conceptual network graph may include a radius N directed weighted graph. Note that the conceptual network graph is generated for a specific agent 150 and context 148 in the AEN. In this regard, the conceptual network does not exist absent the specific agent 150 and the context 148. For example, absent a context 148, the agents 150 are unconnected to one another and include only their individual sink and source memories. Although, the conceptual network may be expressed graphically, as in the illustration of FIG. 4, the conceptual network may also be expressed in a non-graphical representation in the form of, for example, a data array.

Once a context 148 is defined for a particular agent 150 (primary agent), the conceptual network may be populated with the other agents that may be directly connected to the primary agent 150 using directed arcs, referred to as influence links, that communicate weighted directional influence that is specific to the context. For example, as illustrated, the context 148 may be defined as music. The AEN will generate data corresponding to all agents who directly influence the primary agent 150 and all agents who are directly influenced by the primary agent 150. In some embodiments, the weighting that corresponds to the strength of influence may be normalized and be represented by a value between zero and one. For example, the influence on a primary agent 150 who is greatly influenced by second agent 152 may be illustrated as an influence link between the circles that correspond to the agents 150, 152 and includes a weight of, for example, 0.73.

In some embodiments, the AEN may generate additional agents who indirectly influence or are influenced by the primary agent 150 through one or more other agents. For example, agents who directly influence one or more agents who directly influence the primary agent may also be included in the conceptual network. The number of influence links between an agent and the primary agent may be referred to as the degrees of separation. For example, an agent who is influenced by an agent who directly influences the primary agent may be described as having two degrees of separation from the primary agent. In some embodiments, the conceptual network may be configured to generate all agents and influence links having N degrees of separation such that N is any integer value. As a practical matter, if the value of N is selected to be a large number, generating the conceptual network may become excessively data-processing intensive. Additionally, agents that are significantly attenuated from the primary agent 150 may have little influence on the primary agent 150. In some embodiments, the conceptual network may be generated as a radius two network and thus may only include agents within two degrees of separation from the primary agent 150.

In some embodiments, agents in a conceptual network may also have influence regarding contexts that are different from the context upon which the conceptual network is based. In some embodiments, additional influence links may be provided to illustrate the influence that corresponds to contexts other than the context for which the conceptual network was generated. For example, two agents in a conceptual network that is generated in a music context 148 may also have influence links in a fashion context. In some embodiments, the influence links may include colors, patterns and/or other indications that provide context-related distinctions from the primary context. In a non-graphical representation of the conceptual network, an influence link may include a data representation that identifies, defines and/or distinguishes the contexts.

In some embodiments, influence links may be expressed in a context vector. A context vector may include attribute vectors, source/sink vectors, environment vectors, and/or product identifiers, among others.

Thus, given a primary agent 150 and a context 148 in an AEN, a conceptual network around the primary agent 150 in the given context 148 may be expressed. From the conceptual network, social pressures and desirabilities may be computed that may provide predictive data regarding the likelihood that the primary agent will adopt the given context. In some embodiments, the given context may include a presentation, organized and/or an unorganized event, a good, an organization and/or a service.

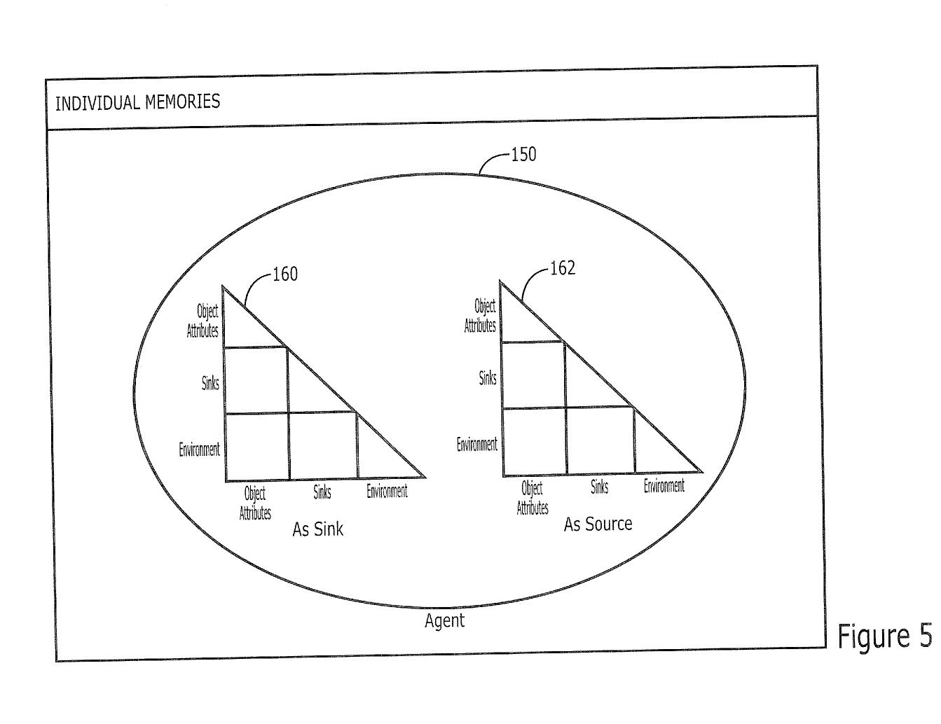

Reference is now made to FIG. 5, which is a diagram illustrating individual sink and source memories 160, 162 of an agent 150 in an associative entity network according to some embodiments of the present invention. As discussed above regarding FIG. 3, individual memories of each agent 150 may include a sink memory 160 and a source memory 162. Each of the sink memory 160 and source memory 162 may be configured as a data array that can map associations corresponding to the various combinations of objects, attributes, and/or sources/sinks.

In some embodiments, a sink memory 160 may be configured as a two dimensional array that includes objects, sources and/or environmental data, among others, along each of the dimensional axes. Objects may be defined by and/or include attributes and/or features that may be described in terms of attribute identifiers (IDs). For example, an object attribute may be a product attribute such as color, style, brand, genre, a specific function and/or appearance. Sources may be assigned and/or represented by a unique identifier such as, for example, nicknames used in social networks and other types of network communities. The sink memory 160 may include environmental information that may correspond to the environment in which an event occurred. For example environmental information may include date, day of the week, time of day, season, weather, climate, political climate, and/or economic climate, among others.

In some embodiments, a source memory 162 may include a two dimensional array that includes objects, sinks and/or environmental data, among others, along each of the dimensional axes. In some embodiments, the source memory 162 and the sink memory 160 may include substantially the same structures as one another except for the source and sink data. For example, within the array, where the sink memory 160 lists source data, the source memory 162 may list sink data. Some embodiments may provide for originator data that is separate from the other data types. Some embodiments may include originator data as an object attribute. Sinks may be assigned and/or represented by a unique identifier such as, for example, nicknames used in social networks and other types of network communities. The source memory 162 may include environmental information that may correspond to the environment in which an event occurred.

Both the sink and source memories 160, 162 may each include array portions that may be analyzed to different types of associations. For example, attribute-to-attribute associations may be determined by analyzing the portion of the array corresponding to the attributes on both axes of the array. In this manner, associations between attributes for an individual sink or source memory 160, 162 may be determined. Additionally, by utilizing the richness of associating product attributes, associations among products, such as, for example, accessories, may be determined. For example, where product and/or object identifiers are included in the sink and/or source memory 160, 162, associations between otherwise unrelated objects may be determined. Additionally, similar determinations may be made in a sink memory 160 regarding sources by determining source-to-source associations and in a source memory 162 regarding sinks by determining sink-to-sink associations. Similar associations regarding environmental factors may be determined.

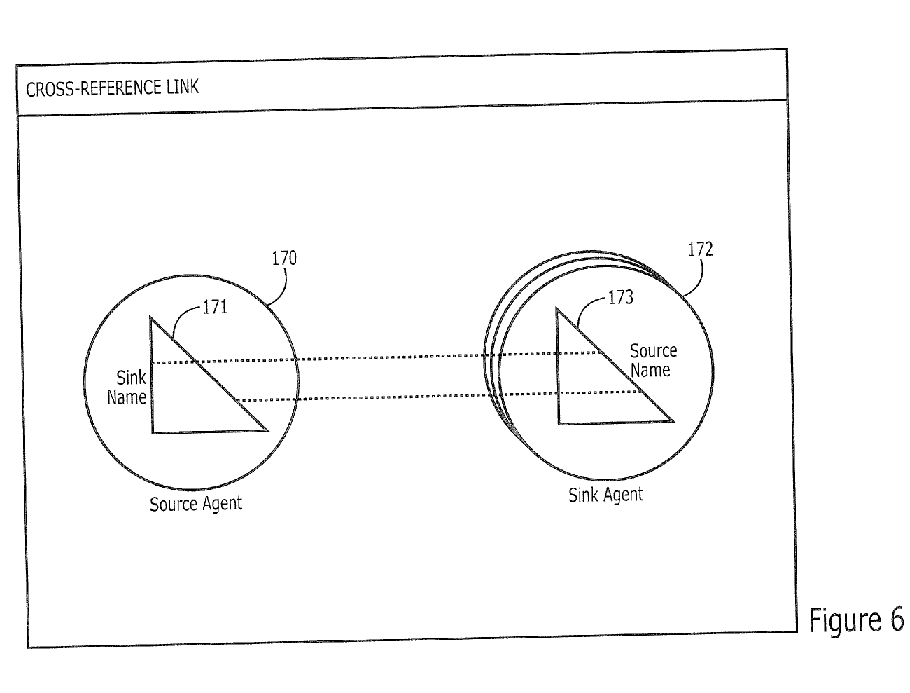

Brief reference is now made to FIG. 6, which is a network diagram illustrating a cross reference link between a source agent 170 and a sink agent 172 in a specific context according to some embodiments of the present invention. The source and sink memories are updated, populated and/or accessed in response to an event in an observe mode. An observe operation may be akin to a write operation in an associative memory and may include accumulating information corresponding to events and/or other agents, among others. An event can include a look event, a buy event, an attention event and/or a return event, among others. In some embodiments, a user may be made aware of the event via a web interface and the events may be measured via click-through detection.

When an event occurs from a user activity, the product attributes, sink information, and/or environmental data, among others, is incremented in the source memory 172 of the source agent 170. Similarly, when the event occurs, the product attributes, source information, and/or environmental data, among others is incremented in the sink memory 173 of the user or sink agent 172. In this manner, for each event, the source agent 170 includes the sink agent name for that event and the sink agent 172 includes the source agent name for that event. Thus, every event may be recorded in two places, the sink memory 173 of the sink agent 172 and the source memory 171 of the source agent 170. Although memory of the individual transaction is lost regarding the sink and source memories, incrementing the respective memories of the sink and source serves to capture the context of multiple source interactions.

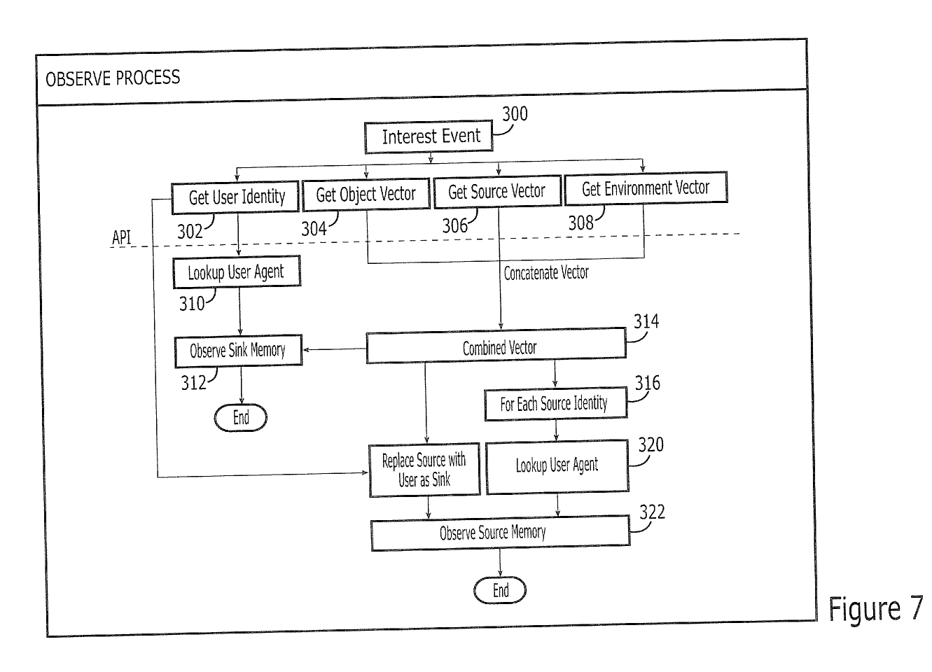

Reference is now made to FIG. 7, which is a flow diagram illustrating an observe process for updating and/or populating sink and source memories in accordance with some embodiments of the present invention. In some embodiments, an observe process is triggered by an interest event 300. An interest event 300 may include any of a variety of events including look events and/or buy events, among others. Look events may include an attention event, as may be measured by, for example, click-through traffic on a Website, and a return event that may record when an agent returns to an item of interest.

An object vector corresponding to the interest event is determined (block 304). The object vector may include a unique object identifier, an object class, and/or object attributes. A source vector corresponding to the source agent(s) is determined (block 306). The sources may be known and/or may accompany the interest event. For example, regarding an article, book, magazine, performance and/or product, sources may include artists, authors, editors, illustrators, promoters, manufacturers, and/or distributors, among others. An environment vector corresponding to environmental conditions at the time of the interest event is determined (block 308). Environmental conditions may include weather, season, time of day, day of the week, mood (if captured), associated buys or interest events, economic trends, and/or other factors that may influence the context. The object, source, and environment vectors are concatenated into a combined vector (block 314).

The user identity is determined (block 302) and the user agent is looked up in the associative memory network (block 310). The sink memory of the user agent observes that the user acted upon influence of the source agent(s) in the context of the object, source(s) and environment, as defined in the combined vector (block 312). In this manner, the user agent sink memory is updated with the source agent(s) and the context in which the source agent(s) influenced the user.

The source information in the combined vector is replaced with the user agent identity (block 318). In this manner, when the source memory of the source agent(s) observes the event, the combined vector will include the user agent identity. For each source identity, the agent identity is looked-up and the source memory observes that the source influenced the user agent in the context of the object, the user agent (sink), and the environment (blocks 320, 322).

Thus, for each interest event, source and sink memories of respective agents observe the objects, object attributes, sources/sinks, and/or environmental conditions. In this manner, information regarding actual influence in social networks may be accumulated by each network agent.

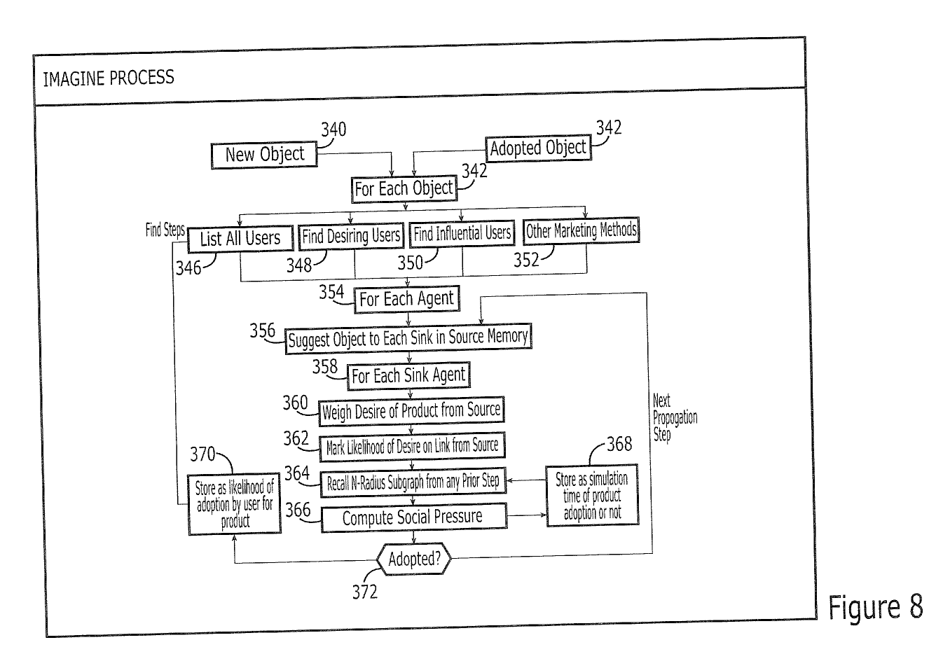

Reference is now made to FIG. 8, which is a flow diagram illustrating an imagine process for simulating and/or estimating propagation of an object and/or product based on the sink and source memories of the network agents in accordance with some embodiments of the present invention. An imagine operation may be akin to a read operation in an associative memory and may include providing information corresponding to estimations and/or predictions based on the information stored in the associative memory. In some embodiments, the imagine process may be used to estimate the propagation of a new object 340. The new object 340 may be defined in terms of multiple object attributes, which may be evaluated collectively to determine what propagation performance might be expected given the current state of the AEN. In some embodiments, the imagine process may be used to estimate the propagation of an adopted object 342 based on identifying influential users in the AEN.

Accordingly, whether a new object 340 or an adopted object 342 are used to define the context, for each object 344, a list of AEN entry points or seeds are determined. In some embodiments, the seeds may include a list of all users (block 346). A benefit of listing all users 346 is that the users in the AEN that are most likely to result in rapid object propagation should be identified. A disadvantage of listing all users as seeds may depend on the size of the AEN and may result in significant data processing resource requirements.

In some embodiments, seeds may be determined by finding desiring users 348. Some embodiments provide that desiring users 348 may be identified by analyzing similar object attributes, through on-line surveys, and/or by identifying early adopters and/or users that have been identified as desiring objects in similar contexts. In some embodiments, the desiring users 348 may be listed as preferred users and/or AEN entry points.

In some embodiments, seeds may be determined by finding influential users 350. Some embodiments provide that influential users 350 may be identified based on network centrality, which may be a function of the social network and may be independent of desirability. For example, influential users 350 may have been sources for a significant number of users who adopted previous and/or similar products or objects.

In some embodiments, seeds may be determined using other marketing methods 352. Other marketing methods 352 may provide, for example, pre-purchased users and/or users selected from the AEN based on one or more selection policies. Some embodiments provide that the list of seeds may include users identified as desiring, influential and/or via marketing methods, alone or in combination.

Once the seeds are identified, each of the seeds may be imagined to be source agents in the context of the object. For each user, or source agent, the object 344 is suggested to each sink that is identified in that source agent's source memory (blocks 345, 356). For each sink agent in that source's memory, the desire for the object 344 for that sink from that source is weighed (block 360). The desire for the object may be determined using a normalized sum of the sink agent's experience using, for example, Bayesian probability, which interprets the concept of probability as a measure of a state of knowledge. The likelihood of desire for the object 344 from that source is marked on the link between the source and sink agents. In some embodiments, the likelihood of desire may become the weight that is used in a conceptual network graph, as discussed above regarding FIGS. 3 and 4.

After the weight for the source and sink agents is determined for the object 344, an N-radius subgraph for that sink agent from any prior step, if any, is recalled (block 364) and is updated with the weight for the source and sink agents. Based on the weights in the N-radius subgraph, the social pressure is computed (block 366) and may be used to determine if the sink agent will adopt the object (block 372).

Some embodiments provide that the time of adoption or not is stored in the simulation (block 368) and may be used to provide the N-radius sub-graph data for subsequent simulation steps. In some embodiments, the desire, social pressure and whether the object is adopted may be stored. Additionally, the likelihood of adoption may be stored for a particular user to identify additional potential seeds (block 370). In this manner, adopters may become seeds for subsequent iterations of the imagine process. After the determination of whether the object is adopted is made, the next propagation step returns to the next sink in the source agent's memory. This process is performed for each seed or source agent. In this manner, the AEN continues to imagine until there are no more seeds. If, for example, the object 344 rapidly propagates through the AEN, each new adopter may become a new seed, which prolongs the imagine process until the rate of adoption goes to zero. The propagation of the object 344 may then be predicted for different sets of seeds to identify any market entry points and/or strategies that may provide more rapid propagation than others.

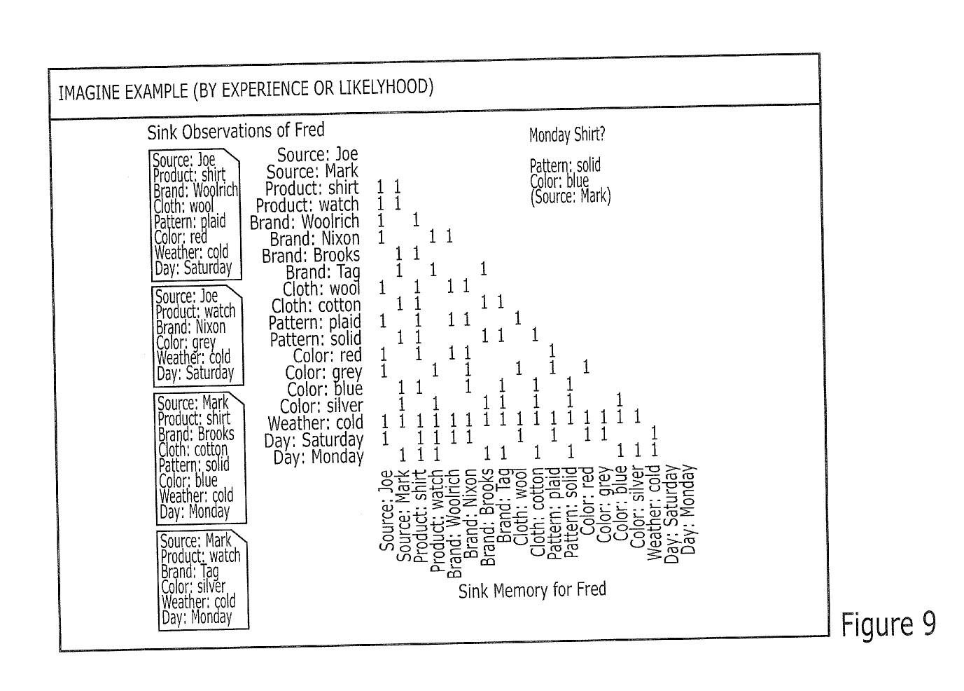

Reference is made to FIG. 9, which is a table illustrating an exemplary sink memory as applied to an imagine example according to some embodiments of the present invention. The AEN may include multiple agents, each including sinks and source memories. The sink memory is a matrix that stores observations made by Fred including sources, products, product attributes and environmental data. In the illustrated example, the context is limited to which shirt to wear on Monday. The row and column associated with Monday are highlighted and the row and column associated with shirt are highlighted. First the color can be imagined by noting that there is one association for red and one association for blue in the shirt column. In the Monday row, there is one association for blue and one association for silver. Using a simple additive model, the shirt color for Monday is imagined to be blue.

Next, the pattern may be imagined as solid since there is one association for plaid and two associations for solid, one in the shirt column and one in the Monday row. Similarly, the source may be determined to be Mark since both Joe and Mark are shirt sources, but only Mark is a Monday source. In this manner, the shirt for Monday and the primary source of influence may be imagined.

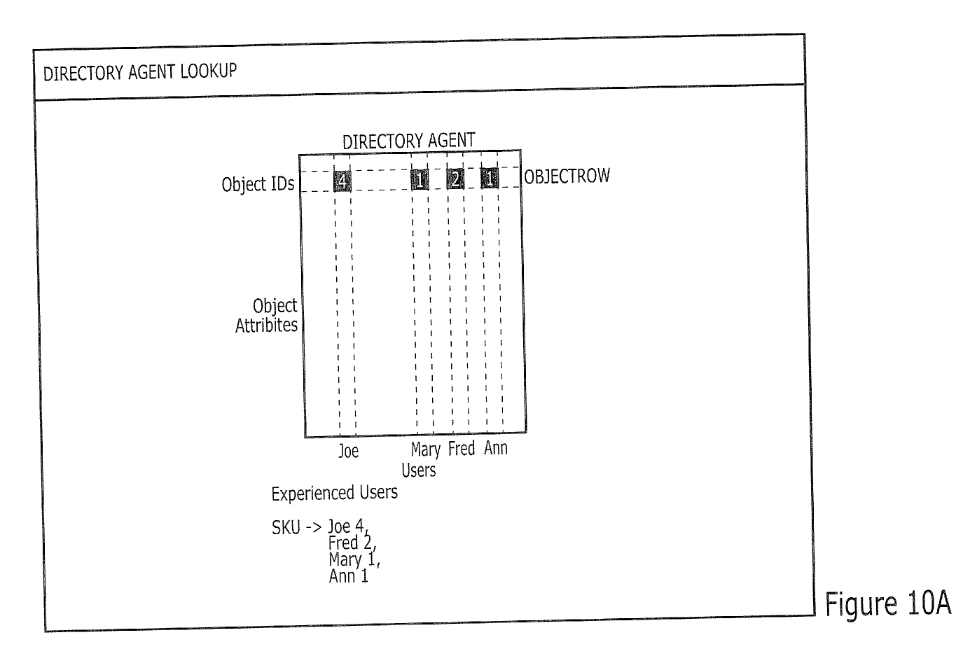

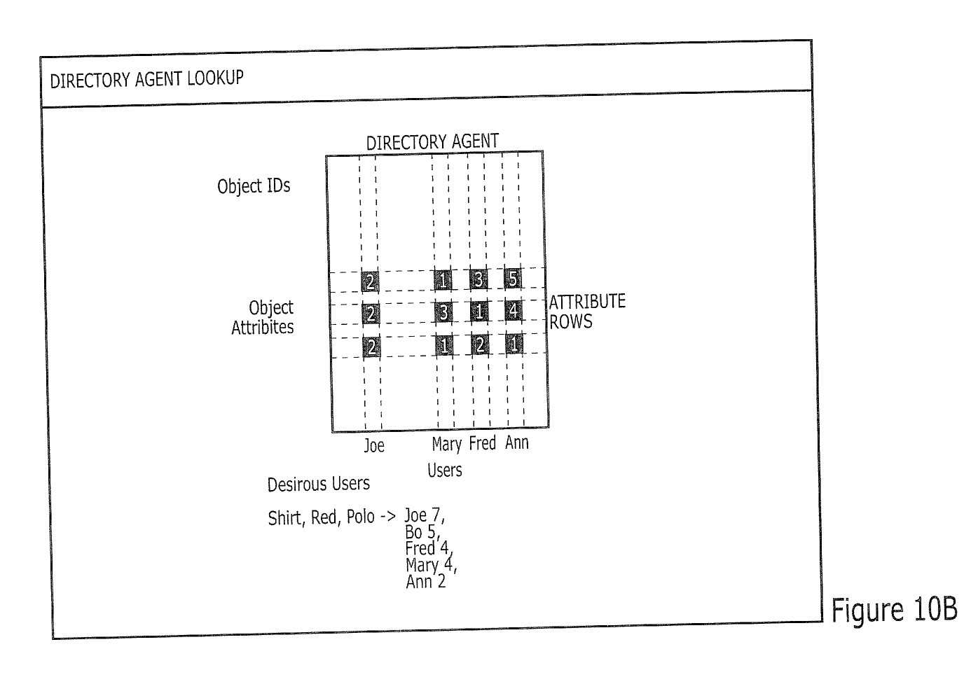

Reference is now made to FIGS. 10A and 10B, which are tables illustrating directory agent look-up functions for finding desiring users according to some embodiments of the present invention. In some embodiments, the look-up functions may correspond to information contained in the memories in the AEN. The look-up functions may correspond to look-up operations discussed above regarding FIG. 7. For example, for updating both the sink and the source memories, the user identity is looked-up (blocks 310, 320). Referring to FIG. 10A, desiring users may be identified for existing products using a directory agent that looks up users having experience and/or an association corresponding to one or more specific objects that may be listed via object identifiers. In some embodiments, this may be accomplished using an index and may include the strength of the experience and/or an association with each of the objects. For example, as illustrated, the user having the most experience and/or the strongest association with the object for the user would be Joe, whose association count is 4, which is greater than the counts of the other users. In this manner, finding desiring users corresponding to existing products may incorporate a data management system using unique identifiers that is similar to and/or includes Stock Keeping System (SKU), Universal Product Code (UPC), European Article Number (EAN), and/or Global Trade Item Number (GTIN) methodologies, among others.

Referring to FIG. 10B, desiring users may be identified for new products using a directory agent that looks up users as a function of object attributes. For example, a directory agent may list users having user memories that indicate adoption of products that included specific attributes. In this manner, a user who has shown an interest in particular attributes may be identified. For example, as illustrated, the user having the most experience and/or the strongest association with the object attributes for the user would be Joe, whose cumulative association count is 7, which is greater than the counts of the other users. The strength of the user's interest in a particular combination of attributes may be determined via a simple linear accumulator method. As discussed above regarding FIG. 8, identifying desiring users may provide the seed points for performing the imagine process.

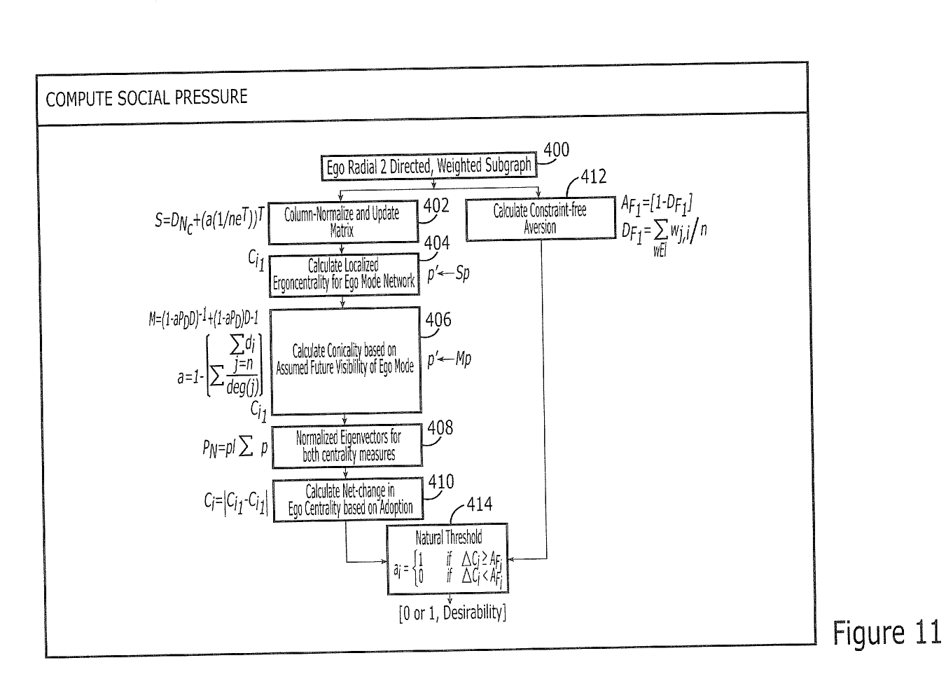

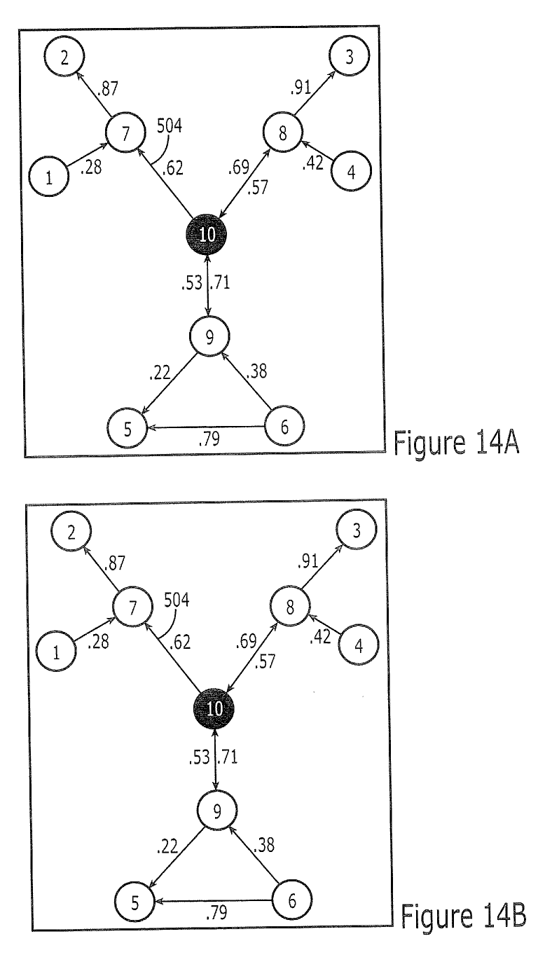

Reference is now made to FIG. 11, which is a flow diagram illustrating computing the social pressure corresponding to a conceptual network generated in an imagine process according to some embodiments of the present invention. The social pressure will result in a binary value that represents whether or not a product is adopted as determined by the social pressure and the constraint free aversion. In some embodiments, an ego radial-2 directed, weighted subgraph 400 typical of one that may be generated during an imagine process may be used to calculate the social pressure. For example, brief reference is made to FIG. 14A, which illustrates an ego radial-2 directed, weighted subgraph. The ego node, as illustrated in black, is a primary node that is measured for determining the primary agent's desirability regarding the object. The subgraph in FIG. 14A may be represented in sparse matrix form as the g×g square matrix:

$$D = \begin{matrix}0 & 0 & 0 & 0 & 0 & 0 & .28 & 0 & 0 & 0 \\ 0 & 0 & 0 & 0 & 0 & 0 & 0 & 0 & 0 & 0 \\ 0 & 0 & 0 & 0 & 0 & 0 & 0 & 0 & 0 & 0 \\ 0 & 0 & 0 & 0 & 0 & 0 & 0 & .42 & 0 & 0 \\ 0 & 0 & 0 & 0 & 0 & 0 & 0 & 0 & 0 & 0 \\ 0 & 0 & 0 & 0 & .79 & 0 & 0 & 0 & .38 & 0 \\ 0 & .87 & 0 & 0 & 0 & 0 & 0 & 0 & 0 & 0 \\ 0 & 0 & .91 & 0 & 0 & 0 & 0 & 0 & 0 & .69 \\ 0 & 0 & 0 & 0 & .22 & 0 & 0 & 0 & 0 & .71 \\ 0 & 0 & 0 & 0 & 0 & 0 & .62 & .57 & .53 & 0\end{matrix} .$$

where elements wᵢⱼ are each a linkage weight between node i and node j.

In some embodiments, computing the social pressure includes calculating the constraint-free aversion 412, which represents the non-desirability regarding the product. The constraint-free aversion, A_{Fi}, may be determined as:

A_{Fi}=(1−D_{Fi}),

where D_{Fi} is the average desirability from all influences and may be determined by:

D_{Fi}=Σ^{w}ᵢⱼ/n,

where wᵢⱼ are the desirability weights from all sources and n is the number of sources.

As provided in block 402, the input matrix D may be column normalized to include column sums of unity to ensure that a dominant eigenvalue will be 1. The column-normalized matrix, DNA, is transformed into a stochastic Markov matrix S having transition probabilities sᵢⱼ using the following equation:

S=D_{NC}+(a(1/ne^{T}))^{T},

where a is the unconnected node vector of length g, n=g, and e is a length g vector of ones. In this manner, S provides a column-normalized and stochastic matrix.

The localized eigencentrality for the ego node network is calculated (block 404). The localized eigencentrality may be calculated using the power method eigenvalue algorithm, which calculates the eigenvector for the dominant eigenvalue of 1. The power method, which is iterative, finds the eigenvalue, λ_{D}, with the largest absolute value. Since S is a stochastic matrix, the power method iteration will converge. Additionally, since the matrix S is sparse and of a small dimension, the convergence should occur quickly. The localized eigenvalue may represent the node's initial centrality, Cᵢₗ.

The centrality based on assumed future visibility of the ego node is calculated (block 406). The centrality based on assumed future visibility may be the equilibrium centrality, C_{iE}, after a collapsing process. In determining the equilibrium centrality, the current and future states of adoption in the node's radial-2 network may be determined. Brief reference is made to FIG. 14B, which illustrates the ego radial-2 directed, weighted subgraph of FIG. 14A with the adoption portfolio identified. Note that nodes 2, 5, 7, and 9 are shaded to represent that they have adopted the object at the initial time step. The state of adoption may be expressed as an adoption portfolio P_{F} that may be represented as a g length vector of adoption values {pi . . . pg} where pi=1 if user i has adopted the object or 0 otherwise. In this regard, the adoption portfolio of the subgraph of FIG. 14B is:
P_{F}={0,1,0,0,1,0,1,0,1,0}.

The matrix may be collapsed by creating new links and weights as well as potentially updating existing weights to reflect increased visibility of nodes that have adopted the object. The matrix may be collapsed as follows:

M_{c}=(I−αP_{D}D)⁻¹+[(I−αP_{D})D−I],

where I is a g×g identity matrix, P_{D} is the diagonalized matrix of the adoption portfolio vector, P_{F}, and α is the network-centric aversion. The network-centric aversion may be equal to or 1 minus the sum of the sum of all n-degree normalized node desirabilities divided by the number of nodes n per the following expression:

$$α = 1 - {\sum }_{d ∈ I} {d}_{j , i} / n$$

In this manner, the matrix M_{C} represents the collapsed graph that takes into account n-path desirabilities attenuated by the overall network aversion. Accordingly, non-desirability is naturally encoded into visibility parameters, and thus, longer paths are not as strong or visual as shorter paths.

The collapsed matrix M_{C} is column normalized and transformed into a stochastic matrix using the operations described above regarding the initial centrality. Similarly, as described above, the eigenvector for the dominant eigenvalue of 1 is determined using the power method iteration. In this manner, the predicted centrality value may be generated as the eigenvalue, λ_{D}, with the largest absolute value. The eigenvalue may represent the node's predicted centrality, C_{iE}.

In both centrality measures, the resulting eigenvector p is normalized by its sum:

$${P}_{N} = \frac{p}{\sum p} ,$$

where P_{N} is the eigencentrality measure for the S matrices (block 408). In this manner, the eigenvectors calculated by different centrality processes may be compared to determine the net change in ego centrality based on adoption (block 410). The net change in centrality, which may be representative of social pressure, may be determined as:

ΔCᵢ=∥Cᵢₗ−C_{iE∥.}

Accordingly, ΔCᵢ is a positive real number that reflects the change in centrality for node i that reflects a contextual centrality adjustment resulting from one or more adoption decisions within the network.

The measure of adoption may be determined as a function of the change in centrality relative to the ego node's lack of desirability or aversion (block 414). In this regard, adoption may be expressed as a binary value relative to whether or not the change in centrality exceeds the constraint-free aversion. Accordingly, adoption, aᵢ, may be expressed as:

aᵢ=1 if ΔCᵢ≧A_{F}

aᵢ=0 if ΔCᵢ<A_{F}

If aᵢ is equal to 1, the user will adopt and if aᵢ is equal to 0 the user will not adopt. In this regard, a node will adopt an object, regardless of its level of aversion if there is a potential threat or gain to the node's perceived centrality, and if that threat or gain is greater than the aversion. In this manner, the adoption process includes a dynamic resistance such that the measure is based on desirability at any given point in time during the contextual process. The dynamic resistance is an effective departure from current diffusion techniques, which rely on hard-coded threshold values that are not indicative of reality. Thus, adoption behaviors and continuous internal attitudes including both social influence and object desirability are considered in contrast with merely considering the actual adoption behavior that is visible to the outside world.

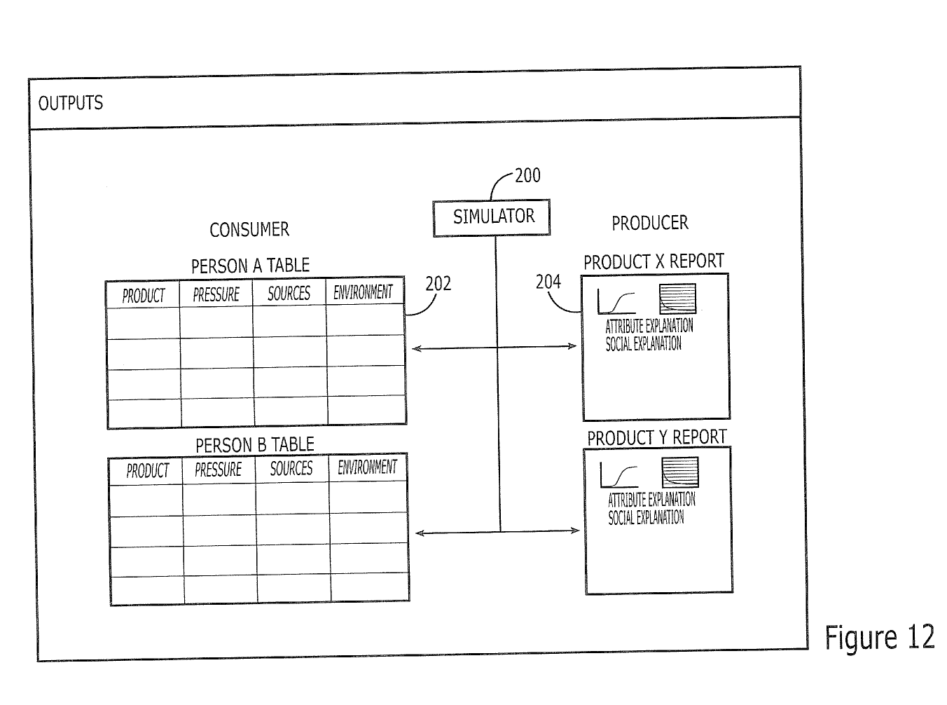

Reference is now made to FIG. 12, which is a block diagram illustrating exemplary outputs from a distributed associative memory operator system according to some embodiments or the present invention. As discussed above regarding FIG. 10, the social pressure on a primary agent may be computed for each product, product attribute, and/or each source of influence. Similarly, the social pressure from a primary agent may be computed for each product, product attribute, and/or each person influenced. A user may be provided a table that is generated by the simulator 200 that lists the products, product attributes, and/or the direction of influence relative to other agents. Some embodiments provide that the simulation of each user may be stored in the associative memory and may be accessed, used and/or updated for subsequent simulations. In this manner, a user may be informed as to who influences them and/or who they influence corresponding to specific objects and/or object attributes. For example, in some embodiments, a consumer table 202 may provide specific data corresponding to social pressure, sources of influence and/or environmental information for each product and/or product attribute.

The simulator 200 may also be configured to provide outputs to producers including, for example, manufacturers, suppliers, distributors, and/or service providers, among others. In some embodiments, producers may receive product reports 204 that may provide attribute explanations and/or social explanations, among others. The product reports 204 may provide useful information as to potential cascade events, rates and incidences of adoption as well as users having significant influence centrality in one or more social networks.

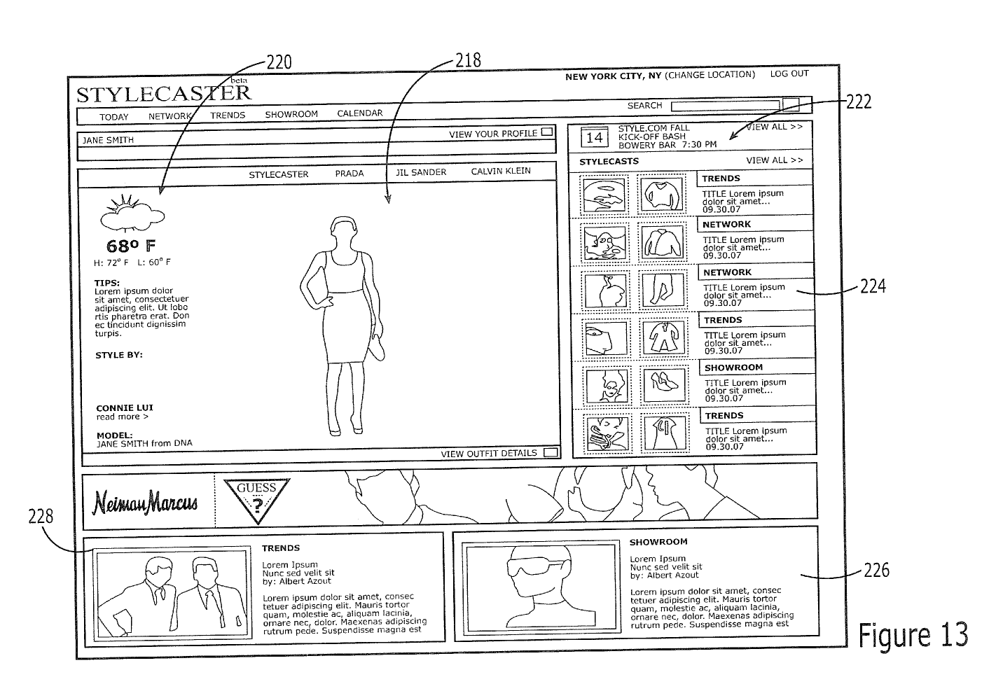

Reference is now made to FIG. 13, which is an image depicting a screenshot of a user interface in accordance with some embodiments of the present invention. In some embodiments, the user interface may be delivered via a data processing device that may be connected to a wide-area network (WAN), a local area network (LAN), a communications network, and/or an Internet network such as, for example, the World Wide Web (Web), among others. The user interface may present leads, objects and/or news items regarding objects. In some embodiments, objects may be products, services and/or events, among others. For example, a user interface may provide one or more suggested fashion ensembles 218, news items 226, event announcements 222, trends 228 and/or recommendations from others 224. In some embodiments, a user interface may further provide environmental information 200 such as, for example, weather, time, political and/or economic news, among others.

Reference is now made to FIG. 14A, which is an example of a directed weighted graph illustrating an exemplary conceptual network graph in a specific context according to some embodiments of the present invention. The conceptual network diagram illustrates multiple agents 1-10 that are connected by directed arcs 504, referred to as influence links, that communicate the weighted directional influence between the agents 1-10 in the specific context. The conceptual network diagram is illustrated as a radial-3 network in which agent 10 is the primary agent. In some embodiments, simulations as herein may provide adoption information. In this regard, reference is now made to FIG. 14B, which is the conceptual network diagram of FIG. 14A including an adoption portfolio. For example, some embodiments provide that agents 2, 5, 7 and 9 are shaded to represent that they have adopted the product, object and/or service. In this regard, the conceptual network diagram may communicate adoption in addition to directional influence among the agents 1-10.

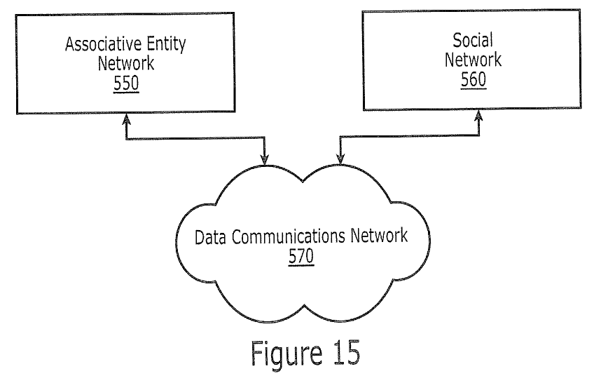

Reference is now made to FIG. 15, which is an exemplary network architecture for a system for providing predictive marketing analysis using at least one associative memory network and a computer-based and/or computer implemented social network, in accordance with some embodiments. The architecture includes an associative entity network 550 including memories of multiple agents corresponding to multiple users in a computer-based social network 560. The associative entity network 550 may be communicatively coupled to the social network 560 via a data communications network 570. The data communications network 570 may operate using a communications protocol such as TCP/IP, and may, for example, be the Internet. It will be appreciated, however, that the data communications network 570 can include any public and/or data communications network, and can operate using any communication protocol. The data communications network 570 may represent a global network, such as the Internet, or other publicly accessible network. The data communications network 570 may also, however, represent a wide area network, a local area network, an Intranet, or other private network, which may not be accessible by the general public. Furthermore, the data communications network 570 may represent a combination of one or more wired and/or wireless public and/or private networks and/or virtual private networks (VPN).

The associative entity network 550 may include one or more servers and may be embodied as one or more computing devices that may be connected by a wired and/or wireless local and/or wide area network, including the Internet.

The computer-based social network 560 may include one or more servers and may be embodied as one or more enterprise, application, personal, pervasive and/or embedded computing devices that may be interconnected by a wired and/or wireless local and/or wide area network, including the Internet. In some embodiments, the social network 560 may include a secure location, such as the central office of a communications services provider.

Although FIG. 15 illustrates an exemplary communications network, it will be understood that the present invention is not limited to such configurations, but is intended to encompass any configuration capable of carrying out the operations described herein. The communications described herein may be organized as client/server communications and/or as peer-to-peer communications.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method of accumulating influence information regarding a user in at least one computer implemented social network, the method comprising:
observing, into a sink portion of a source agent associative memory, source interest event data that corresponds to an interest event in which a user agent is influenced by the source agent; and
observing, into a source portion of a user agent associative memory that corresponds to the user agent, user interest event data that corresponds to the interest event.

2. The method according to claim 1, wherein the interest event includes a look event that corresponds to the user accessing event related information without performing a transaction or a buy event that corresponds to the user conducting a transaction.

3. The method according to claim 1, before observing into the sink portion and before observing into the source portion, further comprising:
determining an object vector corresponding to the interest event that includes a unique object identifier, an object class or object attributes;
determining a source vector corresponding to the interest event that includes interest event source data; and
determining an environment vector corresponding to the interest event that includes interest event environmental data.

4. The method according to claim 3, wherein the interest event environment data includes weather data, season data, temporal data, and/or economic trend data.

5. The method according to claim 1, further comprising generating a combined vector from an object vector, a source vector and an environment vector,
wherein the source interest event data comprises the combined vector and user identification data.

6. The method according to claim 1, further comprising generating a combined vector from an object vector, a source vector and an environment vector,
wherein observing, into a source portion of a user agent associative memory that corresponds to the user agent, user interest event data that corresponds to the interest event comprises:
retrieving user identity data and replacing the source identity data in the combined vector with the user identity data to generate a modified combined vector;
for each source identity, retrieving source user agent identity data and including the source user agent identity data in the modified combined vector; and
storing the modified combined vector in the source portion.

7. A computer program product comprising a computer usable storage medium having computer-readable program code embodied in the medium, the computer-readable program code configured to perform the method of claim 1.

8. A method of simulating adoption propagation of a proposed object in an associative entity network corresponding to at least one computer implemented social network, the method comprising:
generating a plurality of entry points in the associative entity network, the entry points configured to simulate respective source agents for introducing the proposed object into the computer implemented social network; and
determining a likelihood of adoption of the proposed object for each of a plurality of sink agents that are identified in the source agent's source memory.

9. The method according to claim 8, wherein generating the plurality of entry points comprises determining desiring users based on previous user activity that corresponds to a similar object to the proposed object and/or objects including at least one object attribute that is substantially similar to a proposed object attribute.

10. The method according to claim 8, wherein generating the plurality of entry points comprises determining influential users based on respective measures of computer implemented social network centrality.

11. The method according to claim 8, wherein determining a likelihood of adoption of the proposed object for each of a plurality of sink agents that are in identified in the source agent's source memory comprises computing a social pressure as a binary value that represents whether or not the respective sink agents are likely to adopt the proposed object.

12. The method according to claim 11, wherein computing social pressure comprises:
generating an ego radial-N directed, weighted subgraph representing a conceptual network for ones of the plurality of sink agents using respective ones of the sink agents' sink memories, the subgraph including one or more influencing agents and corresponding directional weighted influence values;
estimating a constraint-free aversion for ones of the plurality of sink agents, the constraint-free aversion corresponding to non-desirability of the proposed object;
estimating a net change in centrality of respective ones of the plurality of sink agents to provide indication corresponding to a change in centrality resulting from an adoption decision; and
determining a measure of adoption using the constraint-free aversion and the net change in centrality to determine if the sink agent will adopt the proposed object.

13. The method according to claim 8, wherein determining a likelihood of adoption of the proposed object for each of a plurality of sink agents that are in identified in the source agent's source memory comprises determining a desirability weight for respective ones of the plurality of sink agents corresponding to the proposed object from the source agent.

14. The method according to claim 8, before determining a likelihood of adoption of the proposed object for each of a plurality of sink agents that are in identified in the source agent's source memory, further comprising:
suggesting the proposed object to each of the plurality of sink agents that are in identified in the source agent's source memory; and
storing as a simulation in the associative entity network, a decision regarding whether or not each of the plurality of sink agents adopt the proposed object and a time corresponding to the decision.

15. A computer program product comprising a computer usable storage medium having computer-readable program code embodied in the medium, the computer-readable program code configured to perform the method of claim 8.

16. An associative memory operator system for predictive marketing analysis using a computer implemented social network, the system comprising:
an associative entity network including a plurality of associative memory cells, a respective one of which corresponds to a respective one of a plurality of computer implemented social network users,
wherein a respective associative memory cell comprises:
a sink memory of associations corresponding to which other ones of the plurality of computer implemented social network users have been influenced by the user; and
a source memory of associations corresponding to which ones of the plurality of computer implemented social network users have influenced the user.

17. The associative memory operator system according to claim 16,
wherein the source memory comprises object identification and/or object attribute identification corresponding to an object in which the user influenced a sink user of the plurality of computer implemented social network users and the respective sink user identification, and
wherein the sink memory comprises object identification and/or object attribute identification corresponding to an object in which the user was influenced by a source user of the plurality of computer implemented social network users and the respective source user identification.

18. The associative memory operator system according to claim 17,
wherein the source memory further comprises source environmental data corresponding to the object in which the user influenced the sink user,
wherein the sink memory further comprises sink environmental data corresponding to the object in which the user was influenced by the source user, and
wherein the sink environmental data and the source environmental data each include at least one of date, day of the week, time of day, season, weather, climate, political climate, and/or economic climate.

19. The associative memory operator system according to claim 16, further comprising:
at least one network interface that is configured to present leads, objects and/or news listings regarding objects for consideration by the plurality of computer implemented social network users;
at least one subject-specific web application server that may be accessed via the at least one network interface; and
a computer implemented social network service that may provide an interface between the at least one subject-specific web application server and an associative entity network that includes the plurality of associative memory cells.

20. The associative memory operator system according to claim 17, wherein the object includes at least one of information, a product, a service and an event.

21. The associative memory operator system according to claim 17, wherein the plurality of associative memory cells corresponding to a plurality of computer implemented social network users are operable to perform a simulator function to simulate social pressures between respective ones of the plurality of computer implemented social network users, and wherein the simulator function is further operable to generate reports of objects and/or attributes and a corresponding direction of influence between respective ones of the plurality of computer implemented social network users.

22. The associative memory operator system according to claim 17, further comprising a simulator that is configured to provide predictions corresponding to proposed objects in the computer implemented social network using ones of the plurality of associative memory cells in the associative entity network.

23. A graphical user interface for an associative entity memory corresponding to at least one computer implemented social network, the interface comprising a recommendation portion that is operable to provide recommendations to a user in the at least one computer implemented social network from other ones of a plurality of users in the at least one computer implemented social network using the associative entity network.

24. A system for providing predictive marketing analysis, the system comprising:
a computer implemented social network that is operable to determine personal and social influence information corresponding to a plurality of computer implemented social network users;
a scalable associative memory based entity network platform that is operable to combine with the computer implemented social network to model how information delivery and discovery take place among the plurality of computer implemented social network users, the associative memory including a plurality of individual user memories corresponding to the plurality of computer implemented social network users.

25. The system according to claim 24, wherein the scalable associative memory network is further operable to accumulate influence information corresponding to ones of the plurality of computer implemented social network users and to simulate cascades of objects proposed in the computer implemented social network to provide predictive information regarding delivery of the objects to consumers.

26. The system according to claim 25, wherein cascades of objects proposed in the computer implemented social network are determined algorithmically.
